(19) United States
(12) Patent Application Publication
(10) Pub. No.: US 2013/0095920 A1
(43) Pub. Date: Apr. 18, 2013

(54) GENERATING FREE VIEWPOINT VIDEO USING STEREO IMAGING

(71) Applicants: Kestutis Patiejunas, Sammamish, WA (US); Kanchan Mitra, Woodinville, WA (US); Patrick Sweeney, Woodinville, WA (US); Yaron Eshet, Seattle, WA (US); Adam G. Kirk, Renton, WA (US); Sing Bing Kang, Redmond, WA (US); Charles Lawrence Zitnick, III, Seattle, WA (US); David Eraker, Seattle, WA (US); David Harnett, Seattle, WA (US); Amit Mital, Bellevue, WA (US); Simon Winder, Seattle, WA (US)

(72) Inventors: Kestutis Patiejunas, Sammamish, WA (US); Kanchan Mitra, Woodinville, WA (US); Patrick Sweeney, Woodinville, WA (US); Yaron Eshet, Seattle, WA (US); Adam G. Kirk, Renton, WA (US); Sing Bing Kang, Redmond, WA (US); Charles Lawrence Zitnick, III, Seattle, WA (US); David Eraker, Seattle, WA (US); David Harnett, Seattle, WA (US); Amit Mital, Bellevue, WA (US); Simon Winder, Seattle, WA (US)

(73) Assignee: Microsoft Corporation, Redmond, WA (US)

(21) Appl. No.: 13/273,213

(22) Filed: Oct. 13, 2011

(51) Int. Cl. A63F 13/00; H04N 13/02

(52) U.S. Cl. 463/31; 348/48; 348/E13.074

(57) ABSTRACT

Methods and systems for generating free viewpoint video using an active infrared (IR) stereo module are provided. The method includes computing a depth map for a scene using an active IR stereo module. The depth map may be computed by projecting an IR dot pattern onto the scene, capturing stereo images from each of two or more synchronized IR cameras, detecting dots within the stereo images, computing feature descriptors corresponding to the dots in the stereo images, computing a disparity map between the stereo images, and generating the depth map using the disparity map. The method also includes generating a point cloud for the scene using the depth map, generating a mesh of the point cloud, and generating a projective texture map for the scene from the mesh of the point cloud. The method further includes generating the video for the scene using the projective texture map.

### BACKGROUND

Free Viewpoint Video (FVV) is a technology for video capture and playback in which an entire scene is concurrently captured from multiple angles, and where the viewing perspective is dynamically controlled by the viewer during playback. Unlike traditional video, which is captured by a single camera and characterized by a fixed viewing perspective, FVV capture involves an array of video cameras and related technology to record a video scene from multiple perspectives simultaneously. During playback, intermediate synthetic viewpoints between known real viewpoints are synthesized, allowing for seamless spatial navigation within the camera array. In general, denser camera arrays composed of more video cameras yield more photorealistic results during FVV playback. When there is more real data recorded in a dense camera array, image-based rendering approaches to synthetic viewpoints are more likely to generate high-quality output, since they are informed by more ground truth data. In sparser camera arrays with less real data, more estimates and approximations must be made in generating synthetic viewpoints, and the results are less accurate and therefore less photorealistic.

Newer technologies for active depth sensing, such as the Kinect™ system from Microsoft® Corporation, have improved three-dimensional reconstruction approaches though the use of structured light (i.e., active stereo) to extract geometry from the video scene as opposed to passive methods, which exclusively rely upon image data captured using video cameras under ambient or natural lighting conditions. Structured light approaches allow denser depth data to be extracted for FVV, since the light pattern provides additional texture on the scene for denser stereo matching. By comparison, passive methods usually fail to produce reliable data at surfaces that appear to lack texture under ambient or natural lighting conditions. Because of the ability to produce denser depth data, active stereo techniques tend to require fewer cameras for high-quality 3D scene reconstruction.

With existing technology such as the Kinect™ system from Microsoft® Corporation, an infrared (IR) pattern is projected onto the scene and captured by a single IR camera. The depth map can be extracted by finding local shifts of the light pattern. Despite the advantages of using structured light technology, numerous problems limit the usefulness of similar devices in the creation of FVV.

### SUMMARY

The following presents a simplified summary of the innovation in order to provide a basic understanding of some aspects described herein. This summary is not an extensive overview of the claimed subject matter. It is intended to neither identify key nor critical elements of the claimed subject matter nor delineate the scope of the subject innovation. Its sole purpose is to present some concepts of the claimed subject matter in a simplified form as a prelude to the more detailed description that is presented later.

An embodiment provides a method for generating a video using an active infrared (IR) stereo module. The method includes computing a depth map for a scene using the active IR stereo module. The depth map may be computed by projecting an IR dot pattern onto the scene, capturing stereo images from each of two or more synchronized IR cameras, detecting a plurality of dots within the stereo images, computing a plurality of feature descriptors corresponding to the plurality of dots in the stereo images, computing a disparity map between the stereo images, and generating the depth map for the scene using the disparity map. The method also includes generating a point cloud for the scene in three-dimensional space using the depth map. The method also includes generating a mesh of the point cloud and generating a projective texture map for the scene from the mesh of the point cloud. The method further includes generating the video by combining the projective texture map with real images.

Another embodiment provides a system for generating a video using an active IR stereo module. The system includes a processor configured to implement active IR stereo modules. The active IR stereo modules include a depth map computation module configured to compute a depth map for a scene using the active IR stereo module, wherein the active IR stereo module comprises three or more synchronized cameras and an IR dot pattern projector, and a point cloud generation module configured to generate a point cloud for the scene in three-dimensional space using the depth map. The modules also include a point cloud mesh generation module configured to generate a mesh of the point cloud and a projective texture map generation module configured to generate a projective texture map for the scene from the mesh of the point cloud. Further, the modules include a video generation module configured to generate the video for the scene using the projective texture map.

In addition, another embodiment provides one or more non-volatile computer-readable storage media for storing computer readable instructions. The computer-readable instructions provide a stereo module system for generating a video using an active IR stereo module when executed by one or more processing devices. The computer-readable instructions include code configured to compute a depth map for a scene using an active IR stereo module by projecting an IR dot pattern onto the scene, capturing stereo images from each of two or more synchronized IR cameras, detecting a plurality of dots within the stereo images, computing a plurality of feature descriptors corresponding to the plurality of dots in the stereo images, computing a disparity map between the stereo images, and generating a depth map for the scene using the disparity map. The computer-readable instructions also include code configured to generate a point cloud for the scene in three-dimensional space using the depth map, generate a mesh of the point cloud, generate a projective texture map for the scene from the mesh of the point cloud, and generate the video by combining the projective texture map with real images.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of a stereo module system for generating Free Viewpoint Video (FVV) using an active IR stereo module;

FIG. 2 is a schematic of an active IR stereo module that may be used for the generation of a depth map for a scene;

FIG. 3 is a process flow diagram showing a method for the generation of a depth map using an active IR stereo module;

FIG. 4 is a schematic of a type of binning approach that may be used to identify feature descriptors within stereo images;

FIG. 5 is a schematic of another type of binning approach that may be used to identify feature descriptors within stereo images;

FIG. 6 is process flow diagram showing a method for generating FVV using an active IR stereo module;

FIG. 7 is a schematic of a system of active IR stereo modules connected by a synchronization signal that may be used for the generation of depth maps for a scene;

FIG. 8 is a process flow diagram showing a method for the generation of a depth map for each of two or more genlocked active IR stereo modules;

FIG. 9 is a process flow diagram showing a method for generating FVV using two or more genlocked active IR stereo modules; and

FIG. 10 is a block diagram showing a tangible, computer-readable medium that stores code adapted to generate FVV using an active IR stereo module.

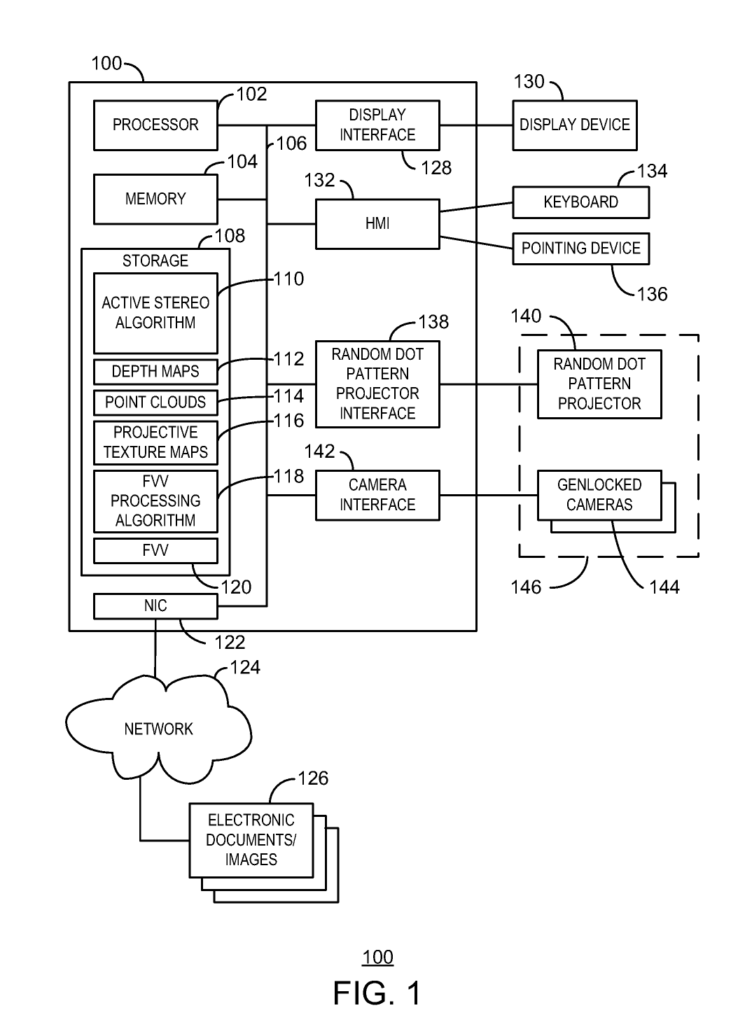

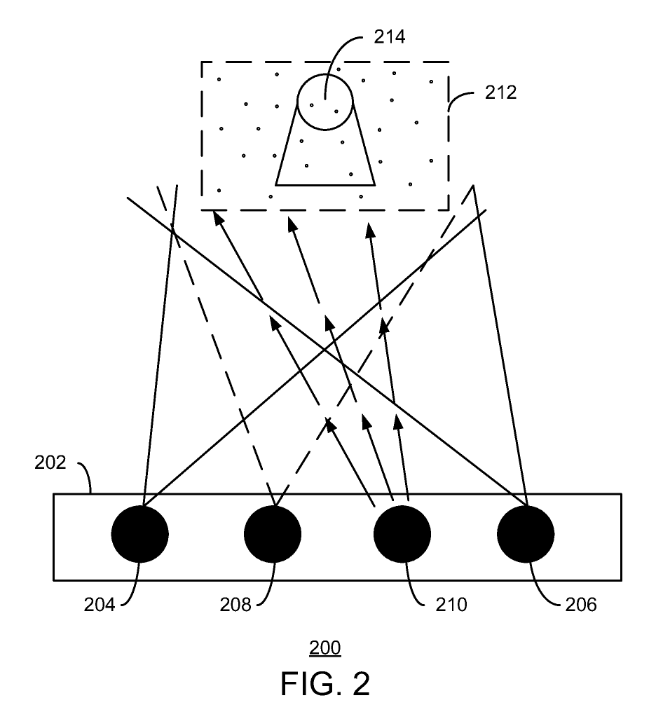

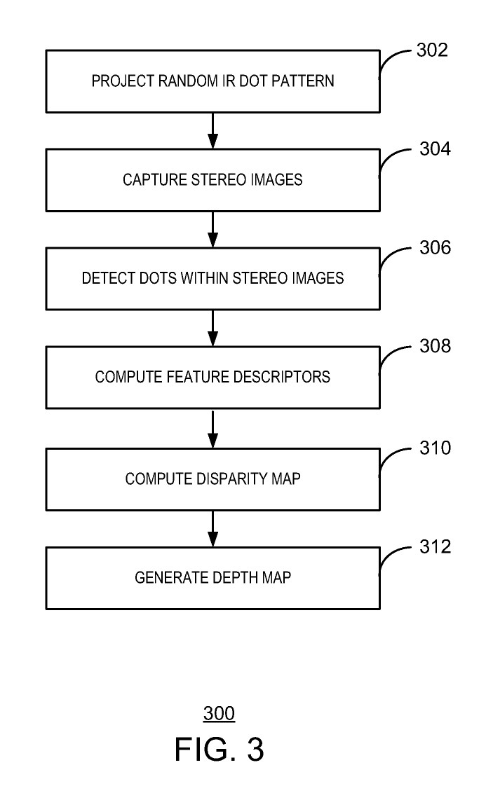

The same numbers are used throughout the disclosure and figures to reference like components and features. Numbers in the 100 series refer to features originally found in FIG. 1, numbers in the 200 series refer to features originally found in FIG. 2, numbers in the 300 series refer to features originally found in FIG. 3, and so on.

### DETAILED DESCRIPTION

As discussed above, Free Viewpoint Video (FVV) is a technology for video playback in which the viewing perspective is dynamically controlled by the viewer. Unlike traditional video, which is captured by a single camera and characterized by a fixed viewing perspective, FVV capture utilizes an array of video cameras and related technology to record a video scene from multiple perspectives simultaneously. Data from the video array are processed using three-dimensional reconstruction methods to extract texture-mapped geometry of the scene. Image-based rendering methods are then used to generate synthetic viewpoints at arbitrary viewpoints. The recovered texture-mapped geometry at every time frame allows the viewer to control both the spatial and temporal location of a virtual camera or viewpoint, which is essentially FVV. In other words, virtual navigation through both space and time is accomplished.

Embodiments disclosed herein set forth a method and system for generating FVV for a scene using active stereopsis. Stereopsis (or just “stereo”) is the process of extracting depth information of a scene from two or more different perspectives. Stereo is characterized as “active” if structured light is used. The three-dimensional view of the scene may be acquired by generating a depth map using a method for disparity detection between the stereo images from the different perspectives.

The depth distribution of the stereo images is determined by matching points across the images. Once the corresponding points within the stereo images have been identified, triangulation is performed to recover the stereo image depths. Triangulation is the process of determining the location of each point in three-dimensional space based on minimizing the back-projection error. The back-projection error is the sum of the distances between projected points of the three-dimensional point onto the stereo images and the originally extracted matching points. Other similar errors may be used for triangulation.

FVV for a scene may be generated using one or more active IR stereo modules in a sparse, wide baseline configuration. A sparse camera array configuration within an active IR stereo module may produce accurate results, since more accurate geometry may be achieved by augmenting a scene with IR light patterns from the active IR stereo modules. The IR light patterns may then be used to enhance image-based rendering approaches by generating more accurate geometry, and these patterns do not interfere with RGB imagery.

In an embodiment, the use of projected IR light onto the scene allows for the extraction of highly accurate geometry from the video of the scene during FVV processing. The use of projected IR light also allows for a sparse camera array, such as four modules in an orbital configuration placed ninety degrees apart, to be used to record the scene at or near the center. In addition, the results obtained using the sparse camera array may be more photorealistic than would be possible with traditional passive stereo.

In an embodiment, a depth map for a scene may be recorded using an active IR stereo module. As used herein, an “active IR stereo module” refers to a type of imaging device which utilizes stereopsis to generate a three-dimensional depth map of a scene. The term “depth map” is commonly used in three-dimensional computer graphics applications to describe an image that contains information relating to the distance from a camera viewpoint to a surface of an object in a scene. Stereo vision uses image features, which may include brightness, to estimate stereo disparity. The disparity map can be converted to a depth map using the intrinsic and extrinsic camera configuration. According to the current method, one or more active IR stereo modules may be utilized to create a three-dimensional depth map for a scene.

The depth map may be generated using a combination of sparse and dense stereo techniques. A dense depth map may be generated using a regularization-based representation such as Markov Random Field. A Markov Random Field is an undirected graphical model that is often used to model various low- to mid-level tasks in image processing and computer vision. A sparse depth map may be generated using feature descriptors. This approach allows for the generation of different depth maps, which may be combined with different probabilities. A higher probability characterizes the sparse depth map, and a lower probability characterizes the dense depth map. For the purposes of the method disclosed herein, the depth map generated using sparse stereopsis may be preferred because sparse data may be more trustworthy than dense data. Sparse depth maps are computed by comparing feature descriptors between stereo images, which tend to either match with very high confidence or not match at all.

In an embodiment, an active IR stereo module may consist of a random infrared (IR) laser dot pattern projector, one or more RGB cameras, and two or more stereo IR cameras, all of which are synchronized (i.e., genlocked). The active IR stereo module may be utilized to project a random IR dot pattern onto a scene using a random IR laser dot pattern projector and to capture stereo images of the scene using two or more genlocked IR cameras. The term “genlocking” is commonly used to describe a technique for maintaining temporal coherence between two or more signals, i.e., synchronization between the signals. Genlocking of the cameras in an active IR stereo module ensures capture occurs exactly at the same time across the camera. This ensures that meshes of moving objects will have the appropriate shape and texture at any given time during FVV navigation.

Dots may be detected within the stereo IR images, and a number of feature descriptors may be computed for the dots. Feature descriptors may provide a starting point for the comparison of the stereo images from two or more genlocked cameras and may include points of interest within the stereo images. For example, specific dots within one stereo image may be analyzed and compared to corresponding dots within another genlocked stereo image.

A disparity map may be computed between two or more stereo images using traditional stereo techniques, and the disparity map may be utilized to generate a depth map for the scene. As used herein, a “disparity map” refers to a distribution of pixel shifts across two or more stereo images. A disparity map may be used to measure the differences between stereo images captured from two or more different, corresponding viewpoints. In addition, simple algorithms may be used to convert a disparity map into a depth map.

It should be noted that the current method is not limited to the use of a random IR dot pattern projector or IR cameras. Rather, any type of pattern projector which projects recognizable feature, such as dots, triangles, grids, or the like, may be used. In addition, any type of camera which is capable of detecting the presence of projected features onto a scene may be used.

In an embodiment, once the depth map for the scene has been determined using the active IR stereo module, a point cloud may be generated for the scene using the depth map. A point cloud is a type of scene geometry that may provide a three-dimensional representation of a scene. Generally speaking, a point cloud is a set of vertices in a three-dimensional coordinate system that may be used to represent the external surface of an object in a scene. Once the point cloud has been generated, surface normals may be calculated for each point in the point cloud.

The three-dimensional point cloud may be used to generate a geometric mesh of the point cloud. As used herein, a geometric mesh is a random grid that is made up of a collection of vertices, edges, and faces that define the shape of a three-dimensional object. RGB image data from the active IR stereo module may be projected onto the mesh of the point cloud to generate a projective texture map. FVV may be generated from the projective texture map by blending the contributions from the RGB image data and the mesh of the point cloud to allow for the viewing of the scene from any number of different camera angles. It is also possible to generate a texture-mapped geometric mesh separately for each stereo module, and rendering involves blending the rendered views of the nearest meshes.

An embodiment provides a system of multiple active IR stereo modules connected by a synchronization signal. The system may include any number of active IR stereo modules, each including three or more genlocked cameras. Specifically, each active IR stereo module may include two or more genlocked IR cameras and one or more genlocked RGB camera. The system of multiple active IR stereo modules may be utilized to generate depth maps for a scene from different positions, or perspectives.

The system of multiple active IR stereo modules may be genlocked using a synchronization signal between the active IR stereo modules. A synchronization signal may be any signal which results in the temporal coherence of the active IR stereo modules. In this embodiment, temporal coherence of the active IR stereo modules ensures that all of the active IR stereo modules are capturing images at the same instant of time, so that the stereo images from the active IR stereo modules will directly relate to each other. Once all of the active IR stereo modules have confirmed the receipt of the synchronization signal, each active IR stereo module may generate a depth map according to the method described above with respect to the single stereo module system.

In an embodiment, the above system of multiple active IR stereo modules utilizes an algorithm that is based on random light in the form of a random IR dot pattern, which is projected onto a scene and recorded with two or more genlocked stereo IR cameras to generate a depth map. As additional active IR stereo modules are used to record the same scene, multiple random IR dot patterns are viewed constructively from the IR cameras in each active IR stereo module. This is possible because multiple active IR stereo modules do not experience interference as more active IR stereo modules are added to the recording array.

The problem of interference between the active IR stereo modules is substantially reduced due to the nature of the random IR dot patterns. Each active IR stereo module is not attempting to match a random IR dot pattern, detected by a camera, to a specific structured original pattern that has been projected onto a scene. Instead, each module is observing the current dot pattern as a random dot texture on the scene. Thus, while the current dot pattern that is being projected onto the scene may be a combination of dots from multiple random IR dot pattern projectors, the actual pattern of the dots is irrelevant, since the dot pattern is not being compared to any standard dot pattern. Therefore, this allows for the use of multiple active IR stereo modules for imaging the same scene without the occurrence of interference. In fact, as more active IR stereo modules are added to a FVV recording array, the amount of features which are visible in the IR spectrum may be increased up to a point, leading to increasingly accurate depth maps.

Once a depth map has been created for each of the active IR stereo modules, each depth map may be used to generate a point cloud for the scene. In addition, the point clouds may be interpolated to include areas of the scene that were not captured by the active IR stereo modules. The point clouds generated by the multiple active IR stereo modules may be combined to create one point cloud for the scene. The combined point cloud may represent image data taken from multiple different perspectives or viewpoints, since each of the active IR stereo modules may record the scene from a different position. In addition, combining the point clouds from the active IR stereo modules may create a single world coordinate system for the scene based on the calibration of the cameras. A mesh of the point cloud may then be created and used to generate FVV of the scene, as described above.

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, and the like, or any combination of these implementations. As used herein, hardware may include computer systems, discrete logic components, such as application specific integrated circuits (ASICs), and the like, as well as any combinations thereof.

As to terminology, the phrase “configured to” encompasses any way that any kind of functionality can be constructed to perform an identified operation. The functionality can be configured to perform an operation using, for instance, software, hardware, firmware and the like, or any combinations thereof.

The term “logic” encompasses any functionality for performing a task. For instance, each operation illustrated in the flowcharts corresponds to logic for performing that operation. An operation can be performed using, for instance, software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

FIG. 1 is a block diagram of a stereo module system 100 for generating FVV using an active IR stereo module. The stereo module system 100 may include a processor 102 that is adapted to execute stored instructions, as well as a memory device 104 that stores instructions that are executable by the processor. The processor 102 can be a single core processor, a multi-core processor, a computing cluster, or any number of other configurations. The memory device 104 can include random access memory (RAM), read only memory (ROM), flash memory, or any other suitable memory systems. These instructions implement a method that includes computing a depth map for a scene using an active IR stereo module, generating a point cloud for a scene in three-dimensional space using the depth map, generating a mesh of the point cloud, generating a projective texture map for the scene from the mesh of the point cloud, and generating FVV by creating a projective texture map. The processor 102 is connected through a bus 106 to one or more input and output devices.

The stereo module system 100 may also include a storage device 108 adapted to store an active stereo algorithm 110, depth maps 112, points clouds 114, projective texture maps 116, a FVV processing algorithm 118, and the FVV 120 generated by the stereo module system 100. The storage device 108 can include a hard drive, an optical drive, a thumbdrive, an array of drives, or any combinations thereof. A network interface controller 122 may be adapted to connect the stereo module system 100 through the bus 106 to a network 124. Through the network 124, electronic text and imaging input documents 126 may be downloaded and stored within the computer's storage system 108. In addition, the stereo module system 100 may transfer depth maps, point clouds, or FVVs over the network 124.

The stereo module system 100 may be linked through the bus 106 to a display interface 128 adapted to connect the system 100 to a display device 130, wherein the display device 130 may include a computer monitor, camera, television, projector, virtual reality display, or mobile device, among others. The display device 130 may also be a three-dimensional, stereoscopic display device. A human machine interface 132 within the stereo module system 100 may connect the system to a keyboard 134 and pointing device 136, wherein the pointing device 136 may include a mouse, trackball, touchpad, joy stick, pointing stick, stylus, or touchscreen, among others. It should also be noted that the stereo module system 100 may include any number of other components, including a printing interface adapted to connect the stereo module system 100 to a printing device, among others.

The stereo module system 100 may also be linked through the bus 106 to a random dot pattern projector interface 138 adapted to connect the stereo module system 100 to a random dot pattern projector 140. In addition, a camera interface 142 may be adapted to connect the stereo module system 100 to three or more genlocked cameras 144, wherein the three or more genlocked cameras may include one or more genlocked RGB camera and two or more genlocked IR cameras. The random dot pattern projector 140 and three or more genlocked cameras 144 may be included within an active IR stereo module 146. In an embodiment, the stereo module system 100 may be connected to multiple active IR stereo modules 146 at one time. In another embodiment, each active IR stereo module 146 may be connected to a separate stereo module system 100. In other words, any number of stereo module systems 100 may be connected to any number of active IR stereo modules 146. In an embodiment, each active IR stereo module 146 may include local storage on the module, such that each active IR stereo module 146 may store an independent view of the scene locally. Further, in another embodiment, the entire system 100 may be included within the active IR stereo module 146. Any number of additional active IR stereo modules may also be connected to the active IR stereo module 146 through the network 124.

FIG. 2 is a schematic 200 of an active IR stereo module 202 that may be used for the generation of a depth map for a scene. As noted, an active IR stereo module 202 may include two IR cameras 204 and 206, an RGB camera 208, and a random dot pattern projector 210. The IR cameras 204 and 206 may be genlocked, or synchronized. The genlocking of the IR cameras 204 and 206 ensures that the cameras are temporally coherent, so that the captured stereo images directly correlate to each other. Further, any number of IR cameras may be added to the active IR stereo module 202 in addition to the two IR cameras 204 and 206. Also, active IR stereo module 202 is not limited to the use of IR cameras, since many other types of cameras may be utilized within the active IR stereo module 202.

The RGB camera 208 may be utilized to capture a color image for the scene by acquiring three different color signals, e.g., red, green, and blue. Any number of additional RGB cameras may be added to the active IR stereo module 202 in addition to the one RGB camera 208. The output of the RGB camera 208 may provide a useful input to the creation of a depth map for FVV applications.

The random dot pattern projector 210 may be used to project a random pattern 212 of IR dots onto a scene 214. In addition, the random dot pattern projector 210 may be replaced with any other type of dot projector.

The two genlocked IR cameras 204 and 206 may be used to capture images of the scene, including the random pattern 212 of IR dots. The images from the two IR cameras 204 and 206 may be analyzed according to the method described below in FIG. 3 to generate a depth map for the scene.

FIG. 3 is a process flow diagram showing a method 300 for the generation of a depth map using an active IR stereo module. At block 302, a random IR dot pattern is projected onto a scene. The random IR dot pattern may be an IR laser dot pattern generated by a projector within an active IR stereo module. The random IR dot pattern may also be any other type of dot pattern, projected by any module in the vicinity of the scene.

At block 304, stereo images may be captured from two or more stereo cameras within an active IR stereo module. The stereo cameras may be IR cameras, as discussed above, and may be genlocked to ensure that the stereo cameras are temporally coherent. The stereo images captured at block 304 may include the projected random IR dot pattern from block 302.

At block 306, dots may be detected within the stereo images. The detection of the dots may be performed within the stereo module system 100. Specifically, the stereo images may be processed by a dot detector within the stereo module system 100 to identify individual dots within the stereo images. The dot detector may also attain sub-pixel accuracy by processing the dot centers.

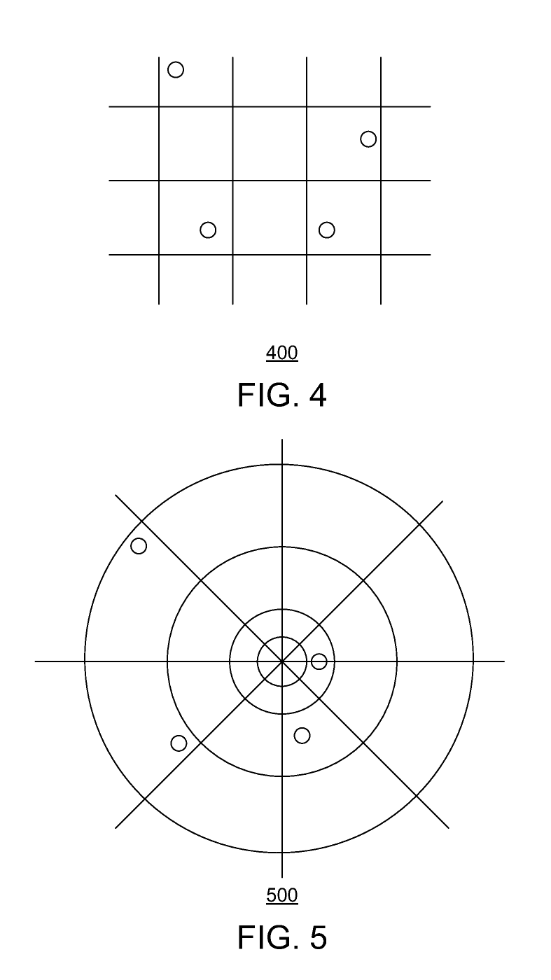

At block 308, feature descriptors may be computed for the dots detected within the stereo images. The feature descriptors may be computed using a number of different approaches, including several different binning approaches, as described below with respect to FIGS. 4 and 5. The feature descriptors may be used to match similar features between the stereo images.

At block 310, a disparity map may be computed between the stereo images. The disparity map may be computed using traditional stereo techniques, such as the active stereo algorithm discussed with respect to FIG. 1. The feature descriptors may also be used to create the disparity map, which may map the similarities between the stereo images according to the identification of corresponding dots within the stereo images.

At block 312, a depth map may be generated using the disparity map from block 310. The depth map may also be computed using traditional stereo techniques, such as the active stereo algorithm discussed with respect to FIG. 1. The depth map may represent a three-dimensional view of a scene. It should be noted that this flow diagram is not intended to indicate that the steps of the method should be executed in any particular order.

FIG. 4 is a schematic of a type of a binning approach 400 that may be used to identify feature descriptors within stereo images. The binning approach 400 utilizes a two-dimensional grid that is applied to a stereo image. The dots within the stereo image may be assigned to specific coordinate locations within a given bin. This may allow for the identification of feature descriptors for individual dots based on the coordinates of neighboring dots.

FIG. 5 is a schematic of another type of binning approach 500 that may be used to identify feature descriptors within stereo images. This binning approach 500 utilizes concentric circles and grids, e.g., a polar coordinate system, which forms another two-dimensional bin framework. A center point is selected for the grids, and each bin may be located by its angle for a selected axis, and its distance from the center point. Within a bin, the dots may be characterized by their spatial location, intensity, or radial location. For spatial localization, bins may be characterized by hard counts for inside dots if there is no ambiguity, or by soft counts for dots which may overlap between bins. For intensity modulation, the aggregate luminance of all dots within a specific bin may be assessed, or an intensity histogram may be computed. In addition, within a specific bin, a radial descriptor may be determined for each dot based on the distance and reference angle between a specific dot and a neighboring dot.

While FIGS. 4 and 5 illustrate two types of binning approaches that may be used to identify feature descriptors in the stereo images, it should be noted that any other type of binning approach may be used. In addition, other approaches for identifying feature descriptors, which are not related to binning, may also be used.

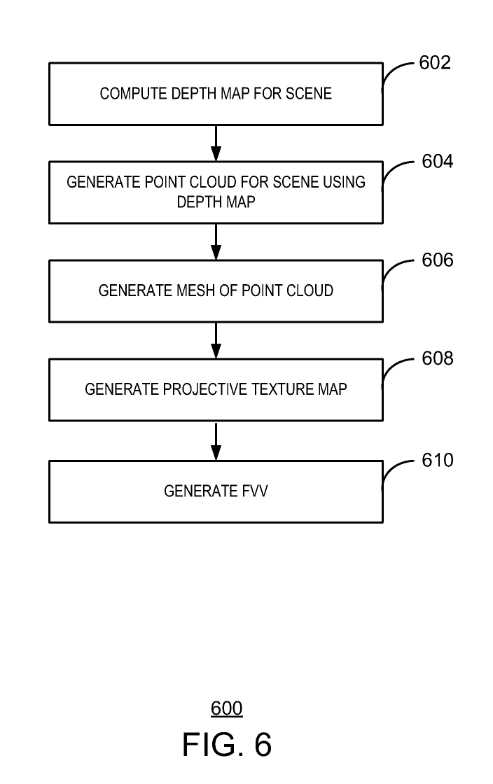

FIG. 6 is process flow diagram showing a method 600 for generating FVV using an active IR stereo module. A single active IR stereo module, as discussed above with respect to FIG. 2, may be used to generate a texture mapped geometric model suitable for FVV rendering with a sparse array of cameras recording a scene. At block 602, a depth map may be computed for the scene using the active IR stereo module, as discussed above with respect to FIG. 3. In addition, the depth map for the scene may be created by using a combination of sparse and dense stereopsis, as described above.

At block 604, a point cloud may be generated for the scene using the depth map. This may be accomplished by converting the depth map into a point cloud in three-dimensional space and calculating surface normals for each point in the point cloud. At block 606, a mesh of the point clouds may be generated to define the shape of the three-dimensional objects in the scene.

At block 608, a projective texture map may be generated by projecting RGB image data from the active IR stereo module onto the mesh of the point cloud. At block 610, FVV may be generated from the projective texture map by blending the contributions from the RGB image data and the mesh of the point cloud to allow for the viewing of the scene from different camera angles. In an embodiment, the FVV may be displayed on a display device, such as three-dimensional, stereoscopic display. In addition, space-time navigation by the user during FVV playback may be enabled. Space-time navigation may allow the user to interactively control the video viewing window in both space and time.

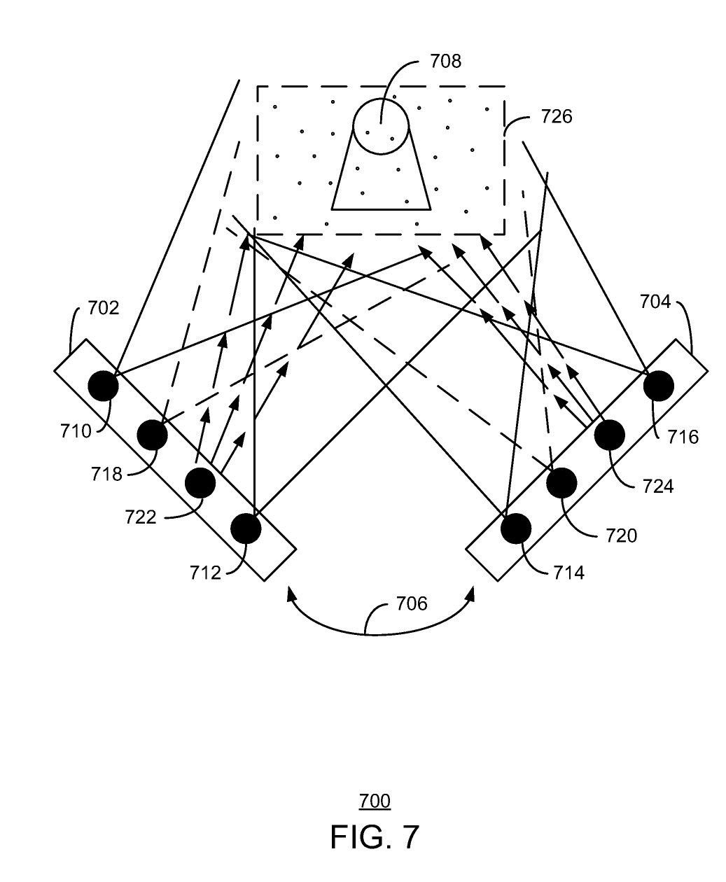

FIG. 7 is a schematic of a system 700 of active IR stereo modules 702 and 704 connected by a synchronization signal 706 that may be used for the generation of depth maps for a scene 708. It should be noted that any number of active IR stereo modules may be employed by the system, in addition to the two active IR stereo modules 702 and 704. Further, each of the active IR stereo modules 702 and 704 may consist of two or more stereo cameras 710, 712, 714, and 716, one or more RGB cameras 718 and 720, and a random dot pattern projector 722 and 724, as discussed above with respect to FIG. 2.

Each of the random dot pattern projectors 722 and 724 for the active IR stereo modules 702 and 704 may be used to project a random IR dot pattern 726 onto the scene 708. It should be noted, however, that not every active IR stereo module 702 and 704 must include a random dot pattern projector 722 and 724. Any number of random IR dot patterns may be projected onto the scene from any number of active IR stereo modules or from any number of separate projection devices that are independent from the active IR stereo modules.

The synchronization signal 706 between the active IR stereo modules 702 and 704 may be used to genlock the active IR stereo modules 702 and 704, so that they are operating at the same instant of time. A depth map may be generated for each of the active IR stereo modules 702 and 704, according the abovementioned method from FIG. 3.

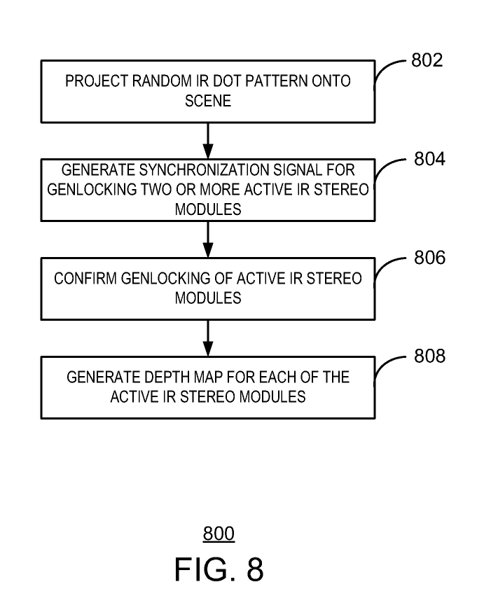

FIG. 8 is a process flow diagram showing a method 800 for the generation of a depth map for each of two or more genlocked active IR stereo modules. At block 802, a random IR dot pattern is projected onto a scene. The random IR dot pattern may be an IR laser dot pattern generated by a projector within an active IR stereo module. The random IR dot pattern may also be any other type of dot pattern, projected by any module in the vicinity of the scene. In addition, any number of the active IR stereo modules within the system may project a random IR dot pattern at the same time. Because of the random nature of the dot patterns, the overlapping of multiple dot patterns onto a scene will not cause interference problems, as discussed above.

At block 804, a synchronization signal may be generated. The synchronization signal may be used for the genlocking of two or more active IR stereo modules. This ensures the temporal coherence of the active IR stereo modules. In addition, the synchronization signal may be generated by one central module and sent to each active IR stereo module, generated by one active IR stereo module and sent to all other active IR stereo modules, generated by each active IR stereo module and sent to every other active IR stereo module, and so on. It should also be noted that either a software or a hardware genlock may be used to maintain temporal coherence between the active IR stereo modules. At block 806, the genlocking of the active IR stereo modules may be confirmed by establishing the receipt of the synchronization signal by each active IR stereo module. At block 808, a depth map for the scene may be generated by each active IR stereo module, according to the method described with respect to FIG. 3. While each active IR stereo module may generate an independent depth map, the genlocking of the active IR stereo modules ensures that all the cameras are recording the scene at the same instant of time. This allows for the creation of an accurate FVV using depth maps taken from multiple different perspectives.

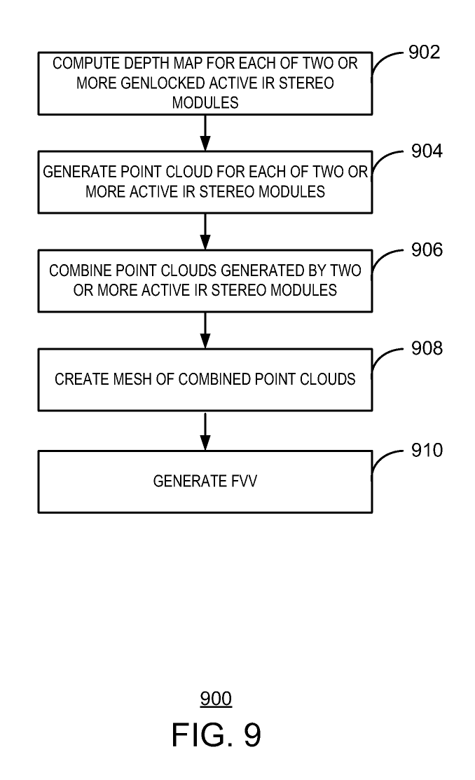

FIG. 9 is a process flow diagram showing a method 900 for generating FVV using two or more genlocked active IR stereo modules. At block 902, a depth map may be computed for each of two or more genlocked active IR stereo modules, as discussed above with respect to FIG. 8. The active IR stereo modules may record a scene from different positions and may be genlocked through a network communication or any type of synchronization signal to ensure that all the cameras in each module are temporally synchronized.

At block 904, a point cloud may be generated for each of the two or more genlocked active IR stereo modules, as discussed with respect to FIG. 6. At block 906, the independently-generated point clouds may be combined into a single point cloud, or world coordinate system, based on the calibration of the cameras in post processing.

At block 908, after normals are calculated for the points, a geometric mesh of combined point clouds may be generated. At block 910, FVV may be generated by creating a projective texture map using RGB image data and the mesh of combined point clouds. The RGB image data may be texture-mapped onto the mesh of combined point clouds in a view-dependent texture mapping, so that different viewing angles produce proportionally blended contributions from the two RGB images. In an embodiment, FVV may be displayed on a display device, and space-time navigation by the user may be enabled.

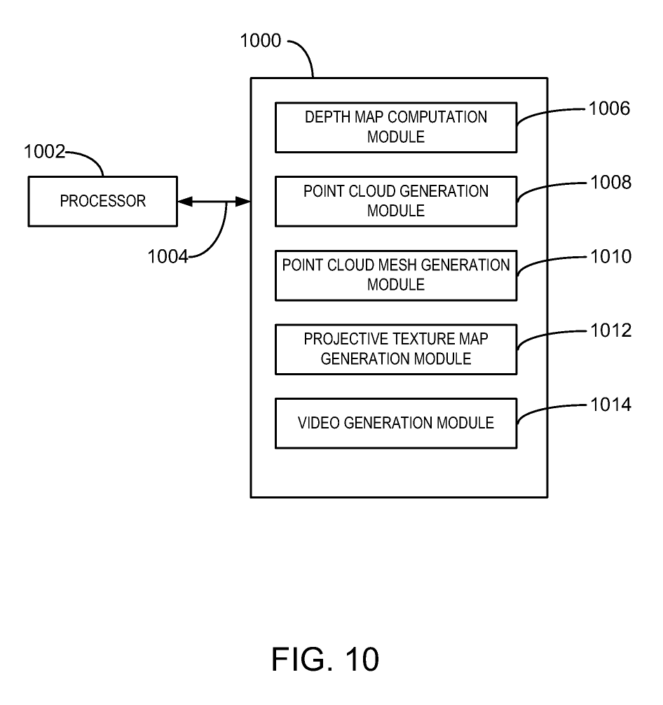

FIG. 10 is a block diagram showing a tangible, computer-readable medium 1000 that stores code adapted to generate FVV using an active IR stereo module. The tangible, computer-readable medium 1000 may be accessed by a processor 1002 over a computer bus 1004. Furthermore, the tangible, computer-readable medium 1000 may include code configured to direct the processor 1002 to perform the steps of the current method.

The various software components discussed herein may be stored on the tangible, computer-readable medium 1000, as indicated in FIG. 10. For example, a depth map computation module 1006 may be configured to compute a depth map for a scene using an active IR stereo module. A point cloud generation module 1008 may be configured to generate a point cloud for a scene in three-dimensional space using the depth map. A point cloud mesh generation module 1010 may be configured to generate a mesh of the point cloud. A projective texture map generation module 1012 may be configured to generate a projective texture map for the scene, and a video generation module 1014 may be configured to generate FVV by combining the projective texture map with real images.

It should be noted that the block diagram of FIG. 10 is not intended to indicate that the tangible, computer-readable medium 1000 must include all the software components 1006, 1008, 1010, 1012, and 1014. In addition, the tangible, computer-readable medium 1000 may include additional software components not shown in FIG. 10. For example, the tangible, computer-readable medium 1000 may also include a video display module configured to display FVV on a display device and a video playback module configured to enable space-time navigation by the user during FVV playback.

In an embodiment, the current system and method may be utilized to create a three-dimensional representation of scene geometry using both sparse and dense data. The points in a particular point cloud created from the sparse data may approach a one hundred percent confidence level, while the points in the point cloud created from the dense data may have a very low confidence level. By blending the sparse and dense data together, the resulting three-dimensional representation of the scene may exhibit a balance between accuracy and richness of the three-dimensional visualization. Thus, in this manner, different types of FVVs may be created depending on the desired qualities of FVV for each specific application.

The current system and method may be used for a variety of applications. In an embodiment, the FVV generated using active stereo may be used for teleconferencing applications. For example, the use of multiple active IR stereo modules to generate FVV for teleconferencing may allow people in separate locations to effectively feel like they are all in the same room.

In another embodiment, the current system and method may be utilized for gaming applications. For example, the use of multiple active IR stereo modules to generate FVV may allow for accurate three-dimensional renderings of multiple people who are playing a game together from separate locations. The dynamic, real-time data captured by the active IR stereo modules may be used to create an augmented reality experience, in which a person playing a game may be able to virtually see the three-dimensional images of the other people who are playing the game from separate locations. The user of the gaming application may also control the viewing window during FVV playback to navigate through space and time. FVV may also be used for coaching athletics, e.g., diving, where performance may be compared by super-imposing performances done at different times or by different athletes.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating a video using an active infrared (IR) stereo module, comprising:
computing a depth map for a scene using the active IR stereo module, wherein computing the depth map comprises:
projecting an IR dot pattern onto the scene;
capturing stereo images from each of two or more synchronized IR cameras;
detecting a plurality of dots within the stereo images;
computing a plurality of feature descriptors corresponding to the plurality of dots in the stereo images;
computing a disparity map between the stereo images; and
generating a depth map for the scene using the disparity map;
generating a point cloud for the scene in three-dimensional space using the depth map;
generating a mesh of the point cloud;
generating a projective texture map for the scene from the mesh of the point cloud; and
generating the video for the scene using the projective texture map.

2. The method of claim 1, wherein the video is a Free Viewpoint Video (FVV).

3. The method of claim 1, comprising:
displaying the video on a display device; and
enabling space-time navigation by a user during video playback.

4. The method of claim 1, comprising capturing stereo images from each of two or more synchronized IR cameras using one or more IR projectors, one or more synchronized RGB camera, or any combination thereof.

5. The method of claim 1, comprising:
computing a depth map for each of two or more synchronized active IR stereo modules;
generating a point cloud for the scene in three-dimensional space for each of the two or more synchronized active IR stereo modules;
combining point clouds generated by the two or more synchronized active IR stereo modules;
creating a mesh of combined point clouds; and
generating the video by creating a projective texture map on the mesh.

6. The method of claim 5, wherein computing the depth map for each of two or more synchronized active IR stereo modules comprises:
projecting an IR dot pattern onto a scene;
generating a synchronization signal for genlocking of the two or more synchronized active IR stereo modules; and
confirming that each of the two or more synchronized active IR stereo modules has received the synchronization signal and, if confirmation is received, generating the depth map for the scene for each of the two or more synchronized active IR stereo modules.

7. The method of claim 1, wherein generating the point cloud for the scene in three-dimensional space using the depth map comprises converting the depth map into a three-dimensional point cloud.

8. The method of claim 1, wherein generating the mesh of the point cloud comprises converting the point cloud into a geometric mesh that is a three-dimensional representation of objects in the scene.

9. The method of claim 1, wherein generating the projective texture map for the scene comprises generating the projective texture map by projecting RGB image data from the active IR stereo module onto the mesh of the point cloud.

10. The method of claim 1, wherein generating the video by creating the projective texture map comprises using image-based rendering methods to combine the projective texture map with real images to create synthetic viewpoints between real images.

11. A system for generating a video using an active infrared (IR) stereo module, comprising:
a processor configured to implement random stereo modules, wherein the random stereo modules comprise:
a depth map computation module configured to compute a depth map for a scene using the active IR stereo module, wherein the active IR stereo module comprises three or more synchronized cameras and an IR dot pattern projector;
a point cloud generation module configured to generate a point cloud for the scene in three-dimensional space using the depth map;
a point cloud mesh generation module configured to generate a mesh of the point cloud;
a projective texture map generation module configured to generate a projective texture map for the scene from the mesh of the point cloud; and
a video generation module configured to generate the video for the scene using the projective texture map.

12. The system of claim 11, comprising:
a processor configured to implement random stereo modules, wherein the random stereo modules comprise:
a video display module configured to display the video on a display device; and
a video playback module configured to enable space-time navigation by a user during video playback.

13. The system of claim 11, wherein the system comprises a conferencing system for generating a real-time video using one or more active IR stereo modules in a room.

14. The system of claim 11, wherein the system comprises a gaming system for generating a real-time video using one or more active IR stereo modules connected to a gaming device.

15. The system of claim 14, wherein the three or more synchronized cameras comprise two or more synchronized IR cameras and one or more synchronized RGB camera.

16. One or more non-volatile computer-readable storage media for storing computer readable instructions, the computer-readable instructions providing a stereo module system for generating a video using an active infrared (IR) stereo module when executed by one or more processing devices, the computer-readable instructions comprising code configured to:
compute a depth map for a scene using the active IR stereo module, wherein computing the depth map comprises:
projecting an IR dot pattern onto the scene;
capturing stereo images from each of two or more synchronized IR cameras;
detecting a plurality of dots within the stereo images;
computing a plurality of feature descriptors corresponding to the plurality of dots in the stereo images;
computing a disparity map between the stereo images; and
generating the depth map for the scene using the disparity map;
generate a point cloud for the scene in three-dimensional space using the depth map;
generate a mesh of the point cloud;
generate a projective texture map for the scene from the mesh of the point cloud; and
generate the video by combining the projective texture map with real images.

17. The non-volatile computer-readable storage media of claim 16, wherein the computer-readable instructions comprise code further configured to:
display the video on a display device; and
enable space-time navigation by a user during video playback.

18. The non-volatile computer-readable storage media of claim 16, wherein the active IR stereo module comprises two or more synchronized IR cameras, one or more synchronized RGB camera, or any combination thereof.

19. The non-volatile computer-readable storage media of claim 16, wherein the computer-readable instructions comprise code further configured to:
compute a depth map for each of two or more synchronized active IR stereo modules;
generate a point cloud for the scene in three-dimensional space for each of the two or more synchronized active IR stereo modules;
combine point clouds generated by the two or more synchronized active IR stereo modules;
create a mesh of combined point clouds; and
generate the video by creating a projective texture map for the scene.

20. The non-volatile computer-readable storage media of claim 19, wherein the code configured to compute the depth map for each of the two or more synchronized active IR stereo modules further comprises code configured to:
project an IR dot pattern onto the scene;
generate a synchronization signal for genlocking of the two or more synchronized active IR stereo modules; and
confirm that each of the two or more synchronized active IR stereo modules has received the synchronization signal and, if confirmation is received, generating the depth map for the scene for each of the two or more synchronized active IR stereo modules.
